(19) United States
(12) Patent Application Publication
(10) Pub. No.: US 2014/0082554 A1
(43) Pub. Date: Mar. 20, 2014

(54) METHOD AND ELECTRONIC DEVICE FOR DISPLAYING CATEGORIES

(71) Applicant: Samsung Electronics Co., Ltd., Gyeonggi-do (KR)

(72) Inventor: Grzegorz IWANISZCZUK, Warsaw (PL)

(73) Assignee: Samsung Electronics Co., Ltd., Gyeonggi-do (KR)

(21) Appl. No.: 14/028,782

(22) Filed: Sep. 17, 2013

(30) Foreign Application Priority Data
Sep. 17, 2012 (KR) 10-2012-0102843

(51) Int. Cl. G06F 3/0482

(52) U.S. Cl. CPC G06F 3/0482
USPC 715/823

(57) ABSTRACT

A method in an electronic device includes: displaying, on a display screen, a plurality of categories, the plurality of categories being displayed in a first direction; detecting, by a processor, a selection of a category from the plurality of categories; modifying an arrangement in which the plurality of categories are displayed, the modifying including displaying the category in a selection region, such that the category is at least partially superimposed over other ones of the plurality of categories, and displaying, on the display screen, a plurality of elements of the category, the plurality of elements being displayed in a second direction that is different from the first direction.

### CROSS-REFERENCE TO RELATED APPLICATION(S) AND CLAIM OF PRIORITY

The present application claims the benefit under 35 U.S.C. §119(a) to a Korean patent application filed in the Korean Intellectual Property Office on Sep. 17, 2012, and assigned Serial No. 10-2012-0102843, the entire disclosure of which is hereby incorporated by reference.

### TECHNICAL FIELD

The present disclosure relates generally to a method end electronic device for displaying categories.

### BACKGROUND

Electronic devices, such as smart phones and tablet computers have become necessities of modern life. Many such electronic devices utilize touchscreens to present information and receive user input. The sizes of the touch screens, however, may be rather small in certain types of electronic devices and this may make it difficult for the electronic devices to present large hierarchical structures, such as multi-tier menus, on these screens. Accordingly, the need exists for new techniques for presenting information that utilizes screen space efficiently.

### SUMMARY

To address the above-discussed needs, it is a primary aspect of the present disclosure to provide an apparatus and a method for displaying a plurality of elements in a limited display area of an electronic device.

In one aspect of the disclosure, a method in an electronic device is provided, comprising: displaying, on a display screen, a plurality of categories, the plurality of categories being displayed in a first direction; detecting, by a processor, a selection of a category from the plurality of categories; modifying an arrangement in which the plurality of categories are displayed, the modifying including displaying the category in a selection region, such that the category is at least partially superimposed over other ones of the plurality of categories, and displaying, on the display screen, a plurality of elements of the category, the plurality of elements being displayed in a second direction that is different from the first direction.

In another aspect of the disclosure, an electronic device is provided comprising a display screen and a processor configured to display, on the display screen, a plurality of categories, the plurality of categories being displayed in a first direction, detect a selection of a category from the plurality of categories, modify an arrangement in which the plurality of categories are displayed, the modifying including displaying the category in a selection region, such that the category is at least partially superimposed over other ones of the plurality of categories, and display, on the display screen, a plurality of elements of the category, the plurality of elements being displayed in a second direction that is different from the first direction.

In yet another aspect, a non-transitory computer-readable medium is provided that stores one or more processor-executable instructions which when executed by the processor cause the processor to perform a method for presenting a menu, the method comprising displaying a plurality of categories, the plurality of categories being displayed in a first direction, detecting a selection of a category from the plurality of categories, modifying an arrangement in which the plurality of categories are displayed, the modifying including displaying the category in a selection region, such that the category is at least partially superimposed over other ones of the plurality of categories, and displaying a plurality of elements of the category, the plurality of elements being displayed in a second direction that is different from the first direction.

Other aspects, advantages, and salient features of the disclosure will become apparent to those skilled in the art from the following detailed description, which, taken in conjunction with the annexed drawings, discloses exemplary embodiments of the disclosure.

### BRIEF DESCRIPTION OF THE DRAWINGS

The above and other aspects, features, and advantages of certain exemplary embodiments of the present disclosure will be more apparent from the following description taken in conjunction with the accompanying drawings, in which:

FIG. 1 is a block diagram of an electronic device for displaying a category according to aspects of the present disclosure;

FIG. 2 is a flowchart of a process for displaying elements according to aspects of the present disclosure;

FIG. 3 is a flowchart of another process for displaying elements according to aspects of the present disclosure;

FIG. 4 is a diagram depicting a plurality of categories and their according to aspects of the present disclosure;

FIGS. 5A and 5B are diagrams of a screen for presentation of information in accordance with aspects of the disclosure;

FIGS. 6A and 6B are diagrams of another screen for presentation of information in accordance with aspects of the disclosure;

FIGS. 7A and 7B are diagrams of yet another screen for presentation of information in accordance with aspects of the disclosure;

FIGS. 8A and 8B are diagrams of yet another screen for presentation of information in accordance with aspects of the disclosure;

FIGS. 9A and 9B are diagrams of yet another screen for presentation of information in accordance with aspects of the disclosure;

FIG. 10A, 10B, 10C and 10D are diagrams of yet another screen for presentation of information in accordance with aspects of the disclosure;

FIGS. 11A and 11B are diagrams of yet another screen for presentation of information in accordance with aspects of the disclosure;

FIGS. 12A and 12B are diagrams of yet another screen for presentation of information in accordance with aspects of the disclosure;

FIG. 13 is a diagram of yet another screen for presentation of information in accordance with aspects of the disclosure;

FIG. 14A, 14B and 14C are diagrams of yet another screen for presentation of information in accordance with aspects of the disclosure;

FIG. 15A, 15B, 15C and 15D are diagrams of yet another screen for presentation of information in accordance with aspects of the disclosure;

FIG. 16 is a flowchart of a still another process for displaying elements according to aspects of the present disclosure; and

FIG. 17 is a flowchart of a further still another process for displaying elements according to aspects of the present disclosure.

Throughout the drawings, like reference numerals will be understood to refer to like parts, elements and structures.

### DETAILED DESCRIPTION

The following description with reference to the accompanying drawings is provided to assist in a comprehensive understanding of the disclosure. It includes various specific details to assist in that understanding but these are to be regarded as merely exemplary. Accordingly, those of ordinary skill in the art will recognize that various changes and modifications of the examples described herein can be made without departing from the scope and spirit of the disclosure. In addition, descriptions of well-known functions and constructions may be omitted for clarity and conciseness.

The terms and words used in the following description and claims are not limited to the bibliographical meanings, but, are merely used to enable a clear and consistent understanding of the disclosure. Accordingly, it should be apparent to those skilled in the art that the following examples are provided for illustrative purposes only and not for the purpose of limiting the disclosure.

It is to be understood that the singular forms “a,” “an,” and “the” include plural referents unless the context clearly dictates otherwise. Thus, for example, reference to “a component surface” includes reference to one or more of such surfaces.

By the term “substantially” it is meant that the recited characteristic, parameter, or value need not be achieved exactly, but that deviations or variations, including for example, tolerances, measurement error, measurement accuracy limitations and other factors known to those of skill in the art, may occur in amounts that do not preclude the effect the characteristic was intended to provide.

In some aspects, techniques are disclosed for efficiently displaying a plurality of categories and elements of those categories in a limited display area. Each of the categories may be associated with a group of elements that belong to the category. For example, a category may be a setup menu and elements belonging to the category may include video setup, and audio setup menu items that permit the user to change settings for the playback of audio or video, respectively. Additionally or alternatively, as another example, each of the categories can include a collection of grouped content items stored on an electronic device. Such content items may include image files, audio files, video files, and/or any other suitable type of files and/or content items.

In some aspects, categories and category elements may be selected by the user of the electronic device by using touchscreen gestures. Each of the gestures may indicate a touch pattern on a touch screen of the electronic device. Examples of gestures may include a touch-and-drag and touch-and-release gestures. Some gestures may be used to select categories while others may be used to select elements of selected categories. The two types of gestures may differ from one another in various characteristics, such as locations where the gestures touch the screen of the device, shape of the gestures, length of the gestures, and/or any other suitable characteristic that can be used to distinguish two types of gestures from one another.

The electronic device can include a portable electronic device such as portable terminal, mobile phone, media player, tablet computer, handheld computer, or Personal Digital Assistant (PDA), and or any other suitable type of device. In some implementations, the electronic device may be a portable electronic device combining two or more functions of those devices. Throughout the disclosure, examples of an electronic device having a touchscreen are mainly provided. Still, one skilled in the art will appreciate that alternative implementations can be devised where other types of input and output devices are used (e.g., keyboards, monitors without touch sensitivity).

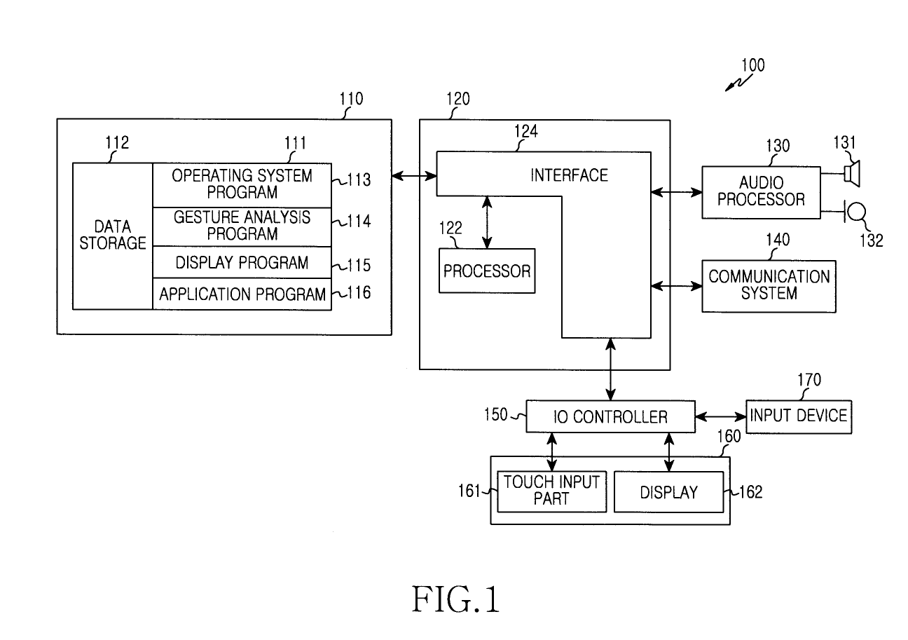

FIG. 1 is a block diagram of an electronic device according to aspects of the disclosure. As shown in FIG. 1, the electronic device 100 can include a memory 110, a processor unit 120, an audio processor 130, a communication system 140, an Input Output (IO) controller 150, a touch screen 160, and an input device 170. The electronic device 100 can include any number of those components, in some implementations.

The memory 110 can include program storage 111 for storing a program to control operations of the electronic device 100 and a data storage 112 for storing data. For example, the data storage 112 can store updatable data such as a phonebook, outgoing messages, and incoming messages. The data storage 112 can store indications of elements and categories associated with each of the elements. The data storage 112 can store at least one user gesture for displaying a given category and/or at least one user gesture for displaying a category element.

The program storage 111 can include an operating system program 113, a gesture analysis program 114, a display program 115, and at least one application program 116. Each of the programs in the program storage 111 may include a plurality of instructions that are executed by one or more of the processors that are part of the electronic device 100 (e.g., processor unit 120).

The operating system program 113 can include various software components for controlling general system operations. These include, e.g., memory management and control, storage hardware (device) control and management, and power control and management. The operating system program 113 processes normal communication between various hardware (devices) and software components (modules).

The gesture analysis program 114 can detect user gestures for displaying categories and category elements. In some implementations, the gesture analysis program 114 may be configured to analyze a user's gesture for altering the arrangement in which categories in a list are displayed. Additionally or alternatively, in some implementations, the gesture analysis program 114 may be configured to alter the arrangement in which category elements are displayed. By way of example, altering the arrangement in which categories in a list are displayed may include changing the order in which the categories are displayed. As another example, altering the arrangement in which category elements are display may include moving one or more of the categories in a vertical and/or horizontal direction. In some implementations, the gesture analysis program 114 can provide indications of detected gestures to the display program 115.

The display program 115 can include various software components for providing and displaying graphics on the touch screen 160. The term ‘graphics’ can include a text, a webpage, an icon, a digital image, a video, and an animation. In some implementations, the display program 115 can display a plurality of categories for displaying different category options that are available to the user. In addition, in some implementations, the display program 115 may display for each one of the plurality of categories, one or more elements (e.g., category options) that belong to that category.

The display program 115 can display the plurality of categories using a first list of regions. Similarly, the display program 115 may display elements of the selected category by using a second list of regions. In some implementations, each of the regions may be a placeholder for display of a category or any other type of element. Additionally or alternatively, each of the regions may be associated with a location on the display screen of the electronic device. Additionally or alternatively, in some implementations, the location may be variable. Additionally or alternatively, in some implementations, the location may be fixed. Additionally or alternatively, in some implementations, each of the regions may have a geometric shape, such a rectangular shape, triangular shape, circular shape, and/or any other suitable shape. Additionally or alternatively, each of the regions may be associated with a category or any other type of components. The display program 115 may display each of the regions by rendering an indication of the category (or any other type of element, such as category element or media file) associated with that region on the display screen of the electronic device. Each region's respective indication of category (or category element) may be displayed at a location associated with that region. The indication may be an image, text, video, animation, and/or any other suitable type of indication.

According to the user's gesture, the display program 115 can change and display the arrangement of the categories or the elements that are displayed using the first and/or second list of regions.

Further, the display program 115 can stack the list regions (the category or element region) and overlap some of the region with other regions. The overlapped region can be displayed with its transparency adjusted.

In some implementations, the display program 115 can display a selection region for selecting one or more of the plurality of categories. The display program 115 can change the category that is displayed in the selection region responsive to a user's gesture. When a new category is selected for display in the selection region, the display program may display elements corresponding to the category.

The display program 115 can change and display element arrangements according to the user gestures.

The application program 116 can include a software component for at least one application program installed in the electronic device 100. In some implementations, aspects of the program 116 can be implemented using hardware. For example, an operating system module, a gesture analysis module, and a display module may be used.

The processor unit 120 can include at least one processor 122 and an interface 124. Herein, the processor 122 and the interface 124 can be integrated onto at least one integrated circuit or embodied separately. The interface 124 can function as the memory interface for controlling access of the processor 122 and the memory 110. The interface 124 can function as a peripheral interface for controlling connections between an IO peripheral of the electronic device 100, and the processor 122.

The processor 122 can control the electronic device 100 to display the category using at least one software program. In so doing, the processor 122 can control to execute at least one program stored in the memory 110 and to provide the function corresponding to the program. For example, the processor 122 can include a display processor for analyzing the user's gesture and displaying the category and the element according to the user's gesture. That is, the category display function of the electronic device 100 can be fulfilled using the software such as program stored in the memory 110 or the hardware such as display processor.

The audio processor 130 can provide an audio interface between the user and the electronic device 100 through a speaker 131 and a microphone 132.

The communication system 140 can process voice communication and data communication of the electronic device 100. The communication system 140 may be divided into a plurality of communication sub-modules for supporting different communication networks. For example, the communication networks can include, but not limited to, a Global System for Mobile communication (GSM) network, an Enhanced Data GSM Environment (EDGE) network, a Code Division Multiple Access (CDMA) network, a W-CDMA network, a Long Term Evolution (LTE) network, an Orthogonal Frequency Division Multiple Access (OFDMA) network, a wireless Local Area Network (LAN), a Bluetooth network, and Near Field Communication (NFC).

The IO controller 150 can provide an interface between the IO device such as touch screen 160 and input device 170, and the interface 124.

The touch screen 160, which is an IO device for outputting and inputting information, can include a touch input part 161 and a display 162.

The touch input part 161 can provide touch information detected through a touch panel, to the processor unit 120 via the IO controller 150. In so doing, the touch input part 161 changes the touch information to an instruction such as touch_down, touch_move, and touch_up and provides the instruction to the processor unit 120. The touch input part 161 can generate the user's gesture for displaying the category and the element.

The display 162 can display status information of the electronic device 100, a character input by the user, a moving picture, and a still picture. For example, the display 162 can display the category list and the element list which are changed in the arrangement according to the user's gesture.

The input device 170 can provide input data generated by the user's selection to the processor unit 120 through the IO controller 150. For example, the input device 170 can include only a control button to control the electronic device 100. For example, the input device 170 may include a keypad for receiving the input data from the user. That is, the input device 170 can generate the input data for displaying the category and the element.

The electronic device 100 can further include components (not shown) for providing additional functions, such as camera module for capturing the image or the video, broadcasting receiver module for receiving the broadcasting, digital music player module such as MP3 module, close-range wireless communication module for close-range wireless communication, and proximity sensor module for sensing proximity, and their software.

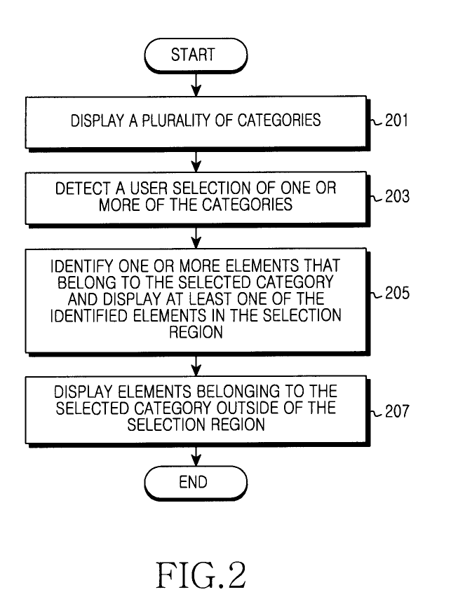

FIG. 2 is a flowchart of a process for displaying elements according to aspects of the disclosure.

Referring to FIG. 2, the electronic device can display a plurality of categories in step 201. Each category may be associated with a plurality of elements. The plurality of categories may be displayed using a first list of regions. In some implementations, each of the regions in the first list may be allocated a different one of the plurality of categories and subsequently displayed. As noted above, displaying a given region may result in an image, text, or another indication of the category assigned to that region being rendered on the electronic device. In some aspects, categories may be displayed by displaying the regions to which the categories have been assigned.

In some instances, a proper subset of the plurality of categories may be displayed at any given time. When only some the categories are displayed, the displayed categories can be scrolled in response to a user gesture, thereby causing unseen categories to become displayed. For example, categories displayed on the screen can be moved to be sequentially concealed while revealing categories that were previously unseen.

In step 203, the electronic device can detect a user selection of one or more of the categories. In some implementations, the selection of the categor(ies) may be detected based on a user's gesture, such as a touch-and-drag or a tap. In some implementations, a selection region may be used to perform the selection. In that regard, the selection may be performed by dragging the category that is being selected into the selection region or otherwise causing that category to appear in the selection region. Additionally or alternatively, the selection may be performed by tapping on the category that is being selected.

In step 205, the electronic device identifies one or more elements that belong to the selected category and displays at least one of the identified elements in the selection region. In some implementations, the selection region may be part of the first list of regions. Additionally or alternatively, in some implementations, the selection region may be part of a second list of regions that is discussed with respect to step 207 below. Additionally or alternatively, in some implementations, the selection region may not be part of either one of the first region and the second region.

In one example, the selection region may not display the selection category but may display at least one of the elements of the selection category. In another example, the selection region may only display the selected category. In yet another example, the selection region can concurrently display the selection category and at least one of the elements of the selection category. In some implementations, the elements of at least one of the categories may be categories themselves. Selecting one of those elements may cause a yet another plurality of elements that are associated with that element to be displayed. In that regard, the above-described technique may be used to accesses hierarchical menus that include any number of tiers. In some implementations, the elements of the selected categories may be files or another type of data, such as video files, picture files, or audio files. Thus, the technique discussed herein may also be used to access media and/or other types of content.

In step 207, the electronic device can display elements belonging to the selected category outside of the selection region. These elements may be displayed by using a second list of regions. More particularly, in some implementations, each of the regions in the second list may be allocated a different one of the elements belonging to the selected category. Afterwards, each of the regions in the second list may be displayed on the display screen of the electronic device. As noted above, displaying a given region may result in an image, text, or another indication of the element that is allocated to the region being rendered on the electronic device. In some aspects, elements may be displayed by displaying the regions to which the elements have been assigned.

In some implementations, the arrangement of elements displayed using the second list of regions may be varied in response to user input. For example, the elements may be scrolled or removed from display responsive to a user gesture. Moreover, in some implementations, elements from the element region can be executed by the electronic device. For example, when a user touches and drags an element “video setup” into the selection region and releases the touch-and-drag, the electronic device can display a video setup screen.

In some implementations, the selection region, the regions from the first list, and the regions from the second list may all be the same size. In other implementations, however, at least one of the selection region, regions from the first list, and regions from the second list may have a different size than the other regions. For example, the selection region may be larger than the regions from the first list and the second list. As another example, regions from the first list may be larger than the regions from the second list. The larger a region, the larger the indication of the element (e.g., an indication of a category, an indication of an element of a category, or an indication of a media file) that is displayed using that region.

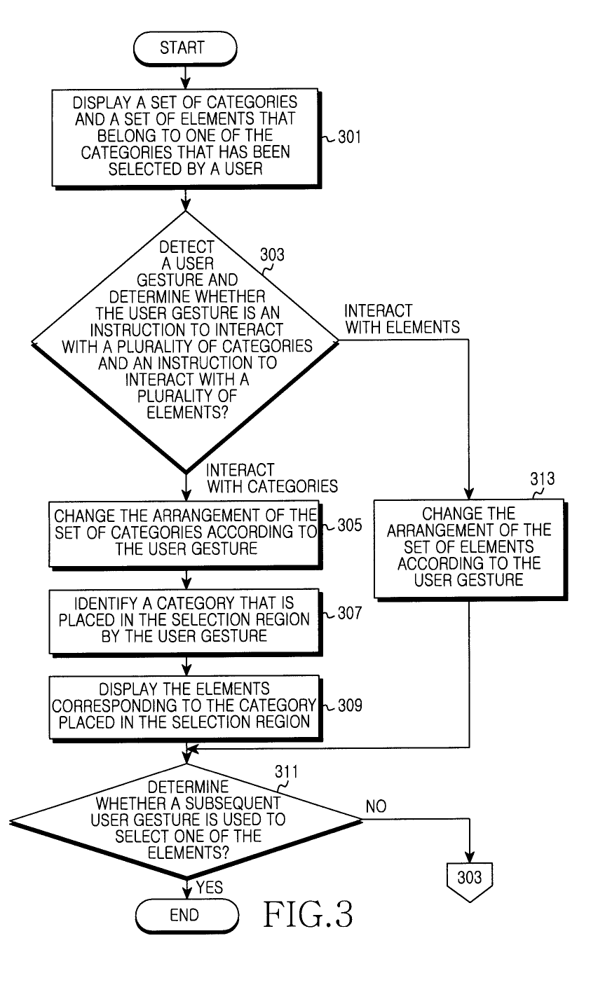

FIG. 3 is a flowchart of another process according to aspects of the disclosure. Referring to FIG. 3, the electronic device can display a plurality of categories by using a first list of regions and a plurality of elements corresponding to one of the plurality of categories that has been selected by a user. Afterwards, the electronic device can execute one of the plurality of elements while changing the arrangement in which the categories and elements are displayed. As noted above, the elements may include subcategories of the selected categories, items that belong to the categories, content items (image data, audio data, and video data) stored in the folder which groups the contents stored in the electronic device, and/or any other suitable type of element.

To execute a given element, the electronic device can display a set of categories and a set of elements that belong to one of the categories that has been selected by a user in step 301. The categories may be displayed using a first list of regions. Displaying the categories may include allocating (or assigning) each of the displayed categories to a (different) region from the first list and displaying that region. Similarly, the elements may be displayed using a second list of regions. Displaying the elements may include allocating (or assigning) each of the displayed elements to a (different) region from the first list and displaying that region.

In step 303, the electronic device detects a user gesture and determines whether the user gesture is one of an instruction to interact with the set of categories and an instruction to interact with the set of elements. When the detected gesture is an instruction to interact with the set of categories, the electronic device can change the arrangement of the set of categories according to the user gesture in step 305. For example, the electronic device can sequentially move the displayed categories in the direction corresponding to the gesture. When the detected gesture is an instruction to interact with the elements, the electronic device can change the arrangement of the elements in a similar fashion.

In step 307, the electronic device can identify a category that is placed in the selection region by the user gesture.

In step 309, the electronic device can display the elements corresponding to the category placed in the selection region, in the second list. In one aspect, displaying the elements may include removing all of the assignments of elements to regions from the second list that were made in step 301. Additionally or alternatively, in another aspect, displaying the elements may include creating new assignments of elements from the newly-selected category to regions from the second list. In step 311, determines whether a subsequent user gesture selects an element of the category that is placed in the selection region. In some implementation. For example, when the user touches and drags the element “video setup” into the selection region and releases the touch-and-drag, the electronic device can determine that the element “video setup” is selected. When the element is selected, the electronic device can execute the selected element.

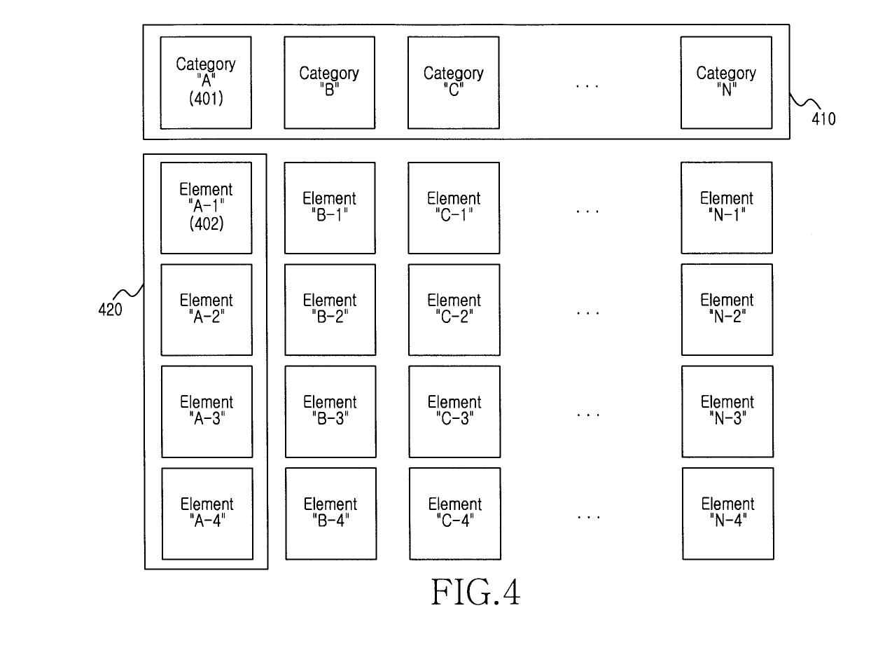

FIG. 4 depicts a diagram of a plurality of categories and their elements according to aspects of the disclosure. Referring to FIG. 4, the electronic device can include a plurality of elements and the elements can be grouped in categories, with each category including one or more of the elements. The categories may be organized in a hierarchical fashion with some categories being higher-order categories (e.g., a menu category such as setup) and some categories being lower-order categories (e.g., menu categories such as audio setup and video setup.) In some implementations, lower-order categories may be elements of the higher-order categories. In some implementations, one or more of the categories may include folders that store content items, such as image files, audio files, video files, etc. In the example of FIG. 4, each category includes multiple elements, and the list of the categories can be defined as a category list 410. The list of the elements of each category can be defined as an element list 420 of the corresponding category. For example, the categories A through N can create one category list, and the elements A-1 through A-4 of the category A 401 can be the elements of the category A 401. Likewise, the categories B through N can include corresponding elements.

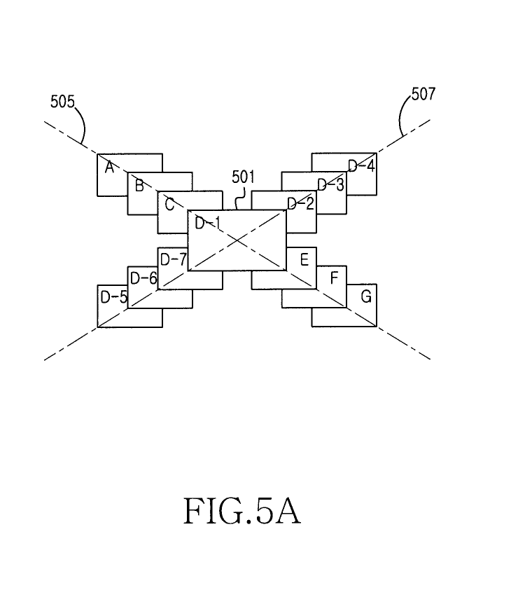

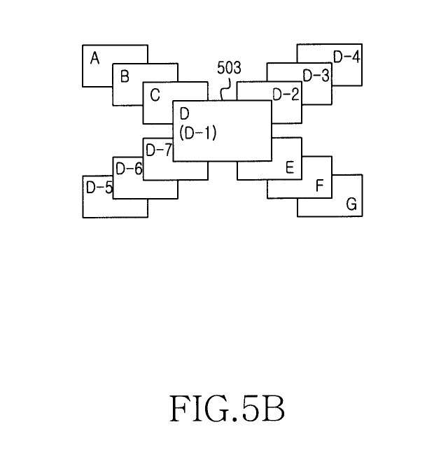

FIGS. 5A and 5B are diagrams of a screen for presentation of information in accordance with aspects of the disclosure. Referring now to FIG. 5A, the electronic device can display a first list and a second list of regions. Each region of the first list can include a category, and each region of the second list can include an element. In other words, the first list (the category list) can enumerate category display regions, and the second list (the element list) can enumerate the element display regions. More specifically, in the example of FIG. 5A, the first list and the second list starting from the different directions can be displayed diagonally. The regions of the first list, displayed from the top left to the bottom right, can be allocated categories. The allocated categories may be selected from a plurality of categories. In some implementations, at least some of the plurality of categories may not be allocated to one of the regions in the first list. In such implementations, when a category is not allocated, that category is not displayed in one of the regions from the first list.

The selection region 501 can be allocated at least one of the plurality of categories that has been selected by a user of the electronic device. In the example FIG. 5A, the category D can be placed in the selection region and the other categories can be arranged based on the selection region 501.

The electronic device can display both of the first list and the second list. In some implementations, the electronic device can generate and sequentially stack the regions (the category regions) associated with the first list, so that at least one of the regions overlaps with other regions. Notably, the overlapped region can be displayed by adjusting its transparency. The regions can be piled from different directions toward one region.

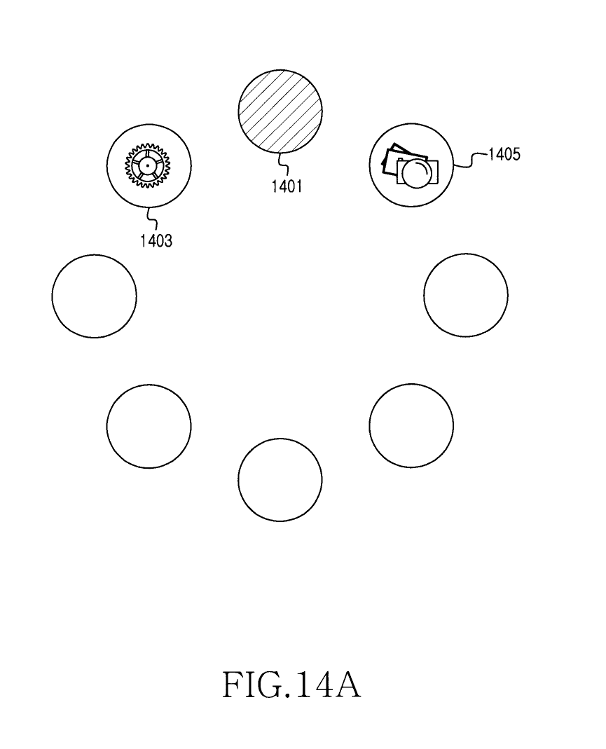

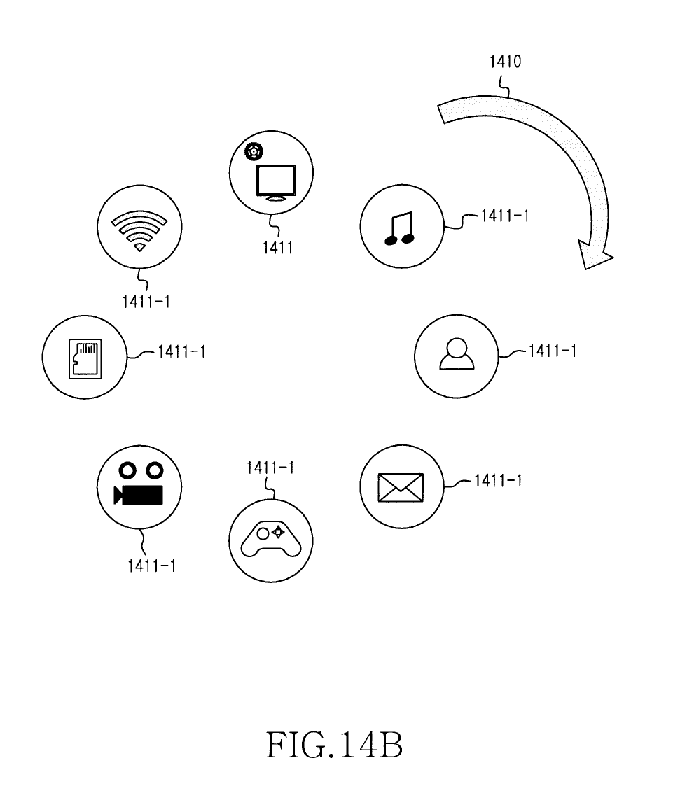

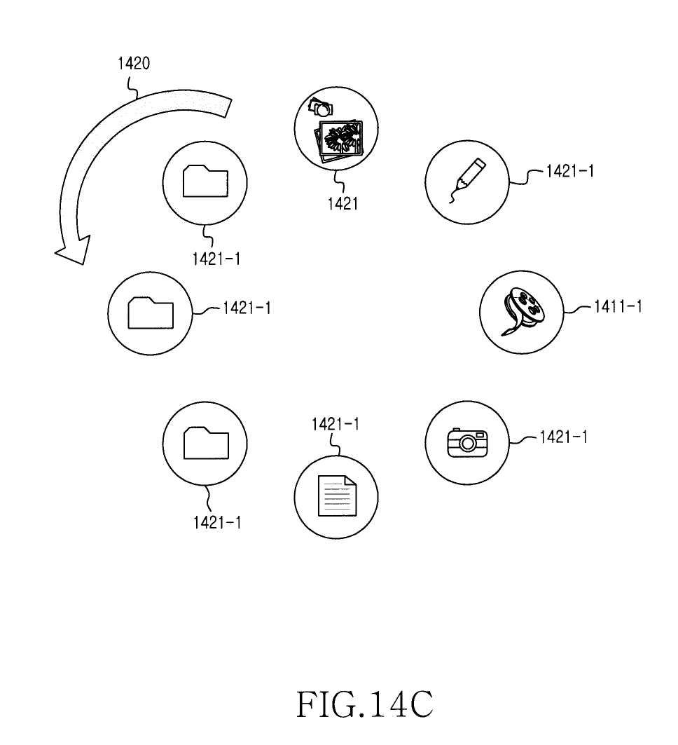

The first list and the second list can be displayed in different directions. For example, the regions from the first list can be situated (or aligned) along a line 505 and the regions from the second list can be situated (or aligned) along a line 507 that crosses line 505. Although in this example, lines 505 and 507 are straight lines, in other examples they can have any suitable shape (e.g., a curved shape, etc.). For instance, in the example of FIG. 14A below, elements are arranged along a line that has the shape of a circle.

In some implementations, the selection region 501 may be situated at an intersection of the first list and the second list. When it is situated on the intersection of the first list and the second list, the selection region may be situated on both the lines 505 and 507. Additionally or alternatively, when it is situated on the intersection of the first list and the second list, the selection region may be situated on both the lines 505 and 507, the selection region may be aligned along line 505 with the regions from the first list and aligned along line 507 with the regions from the second list. The selection region 501 may thus be positioned among the elements from the first list and/or among the elements from the second list. Thus, in some implementations, the electronic device may display the first list and the second list as intersecting at a selection region that indicates at least one of a user selection of a region from the first list or a one or more elements that belong to the region that is selected.

In some implementations, the arrangement of the first list can be changed by a user gesture (e.g., a touch-and-drag along line 507). For example, when the user gestures in a first direction (e.g., from the top left to the bottom right), the categories displayed using first list can be moved by a certain range in the first direction. In some implementations, moving the categories may result in a new category being placed in the selection region. Thus, in some implementations, the user gesture may result in a new category, (e.g., category C) being selected and put in the selection region 501. The category movement range can be determined by the user gesture (length, number of times, speed, and pressure of the gesture). For example, the user gesture can use a touch-and-drag. When a touch-and-drag of a preset length is detected, the displayed categories can be scrolled in the touch-and-drag direction by one region. By contrast, when the touch-and-drag over the preset length is detected, the displayed categories can be scrolled by two regions in the touch-and-drag direction.

More specifically, in some implementations, when a user gestures is detected at the electronic device, the regions in the first list can be allocated new categories and re-rendered, thereby giving the appearance that the categories displayed by the electronic device are rotated and moved to the right by one region. Additionally or alternatively, in some implementations the categories may be moved by changing a coordinate assigned to each of the regions from a first value to a second value, and re-rendering the region on the screen at the second coordinate.

In some implementations, the user gesture for moving the category need not follow the line along which the elements from the first list are aligned. For example, the user can scroll the categories by one region in the first direction, using a gesture which makes a circle. In some implementations, that gesture may be placed outside of the first list (i.e., the gesture need not touch the indications of any of the categories that are displayed on the electronic device).

In the example of FIG. 5A, the second list includes elements D-1 through D-7. Like the categories of the first list, the user can also change the arrangement of the elements in the second list. For example, the user can select the element to execute by placing the intended element in the selection region using a gesture (e.g., the user can perform a touch-and-drag along line 507 causing a new element to slide (or scroll) into the selection region). Any type of user gesture may be used. In some implementations, a user gesture for moving the elements may be made on the second list (e.g., a touch-and-drag along line 507). In other implementations, however the user gesture may be performed outside of the second list. Herein, the user gesture can be distinguished from the gesture on the first list.

When a user makes a new selection of a category from the first list, the electronic device can display the elements of the newly-selected category in the second list. In some implementations, the selection region 501 of FIG. 5A can display only one or more of the elements of the selected category without giving indication of the selected category. In such implementations, however, the user cannot recognize the category of the displayed element(s) based on the second list. To address this shortcoming, the electronic device can display in the selection region 501 both the selected category elements belonging to the selected category as shown in FIG. 5B.

In the example of FIG. 5B, the first list and the second list starting from different directions are displayed diagonally based on the selection region 503. The regions of the first list displayed from the top left to the bottom right can be allocated the categories A through G. The first list includes the multiple regions, as stated earlier. The selection region 503 can include at least one of the categories of the first list that has been selected by the user. In the example of FIG. 5B, category D is be placed in the selection region 503 and the other categories are arranged based on the selection region 503. Furthermore, in this example, the selection region 503 displays the element D-1 of the category D together with the category D of the element.

Although not shown in FIG. 5A and FIG. 5B, in some implementations the elements of the second list may themselves be categories. In this case, a region not overlapping with the first list and the second list can display a third list of elements that belong to a category from the second list that has been selected by the user. In some implementations, the selection region 501 may be used to display also at least some of the elements from the category of the second list. For instance, the selection region may display: (1) category D to indicate that category D has been selected by a user from the first list; (2) sub-category D-1 to indicate that subcategory D-1 has been selected from the second list by the user; and (3) one or more elements of the subcategory D-1.

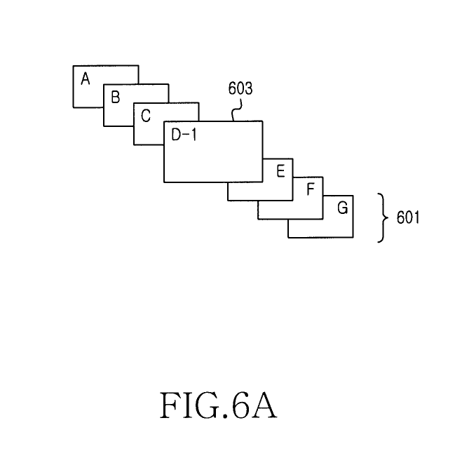

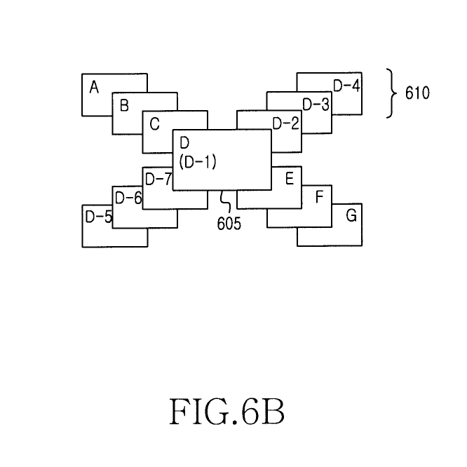

FIGS. 6A and 6B are diagrams of another screen for presentation of information in accordance with aspects of the disclosure. As illustrated, the electronic device can display a first list and a second list. The first list can include regions for displaying categories of grouped elements, and the second list can include regions for displaying the elements of a category that is selected by a user. The electronic device, as noted, can display the first list and then display the second list when the selection of the category is made, rather than displaying the first list and the second list at the same time. When a category is selected by a user, that category can be placed in the selection region.

The first list can include a plurality of regions, and each one of those regions may be allocated a respective one of a plurality of categories. The second list can include a plurality of regions, and each one of those regions may be allocated elements that are associated with a category, displayed using the first list, that has been selected by the user.

The electronic device can display the first list as shown in FIG. 6A. The regions of the first list can be layered, and some of the regions can overlap with one another. The overlapped regions can be displayed by adjusting their transparency.

The regions in the first list can be arranged on different sides of a center region (the region of the category D). The center region can be defined as a selection region 603. The selection region can display the elements of a category displayed using the first list that has been selected by a user. The selection region may have a larger size than the other regions.

The first list 601 is displayed from the top left to the bottom right, and the regions of the first list 601 are allocated the categories A through G. The category D can be placed in the selection region 603 of the first list 601.

The arrangement of the categories of the first list 601 can be changed by a user gesture. For example, when the user gestures in a first direction (e.g., from the top left to the bottom right), the categories of the first list can be moved by a certain range in the first direction. That is, the categories A through G can be rotated and moved to the right by one region. As a result of the rotation, the category C can be put in the selection region and the category G may be moved from the rightmost region of the list to the region's leftmost region. The category movement range can be determined by the user gesture (length, number of times, speed, and pressure of the gesture). For example, the user gesture can include a touch-and-drag. When the touch-and-drag of a preset length is detected, the displayed categories can be scrolled in the touch-and-drag direction by one region. By contrast, when the touch-and-drag over the preset length is detected, the displayed categories can be scrolled by two regions in the touch-and-drag direction.

As noted, the user can select one of the categories displayed using the first list by placing a given one of those categories in the selection region. When a category is selected, the electronic device can display a second list 610 based on the selection as shown in FIG. 6B. The list 610 may include a plurality of regions, with each region being allocated a given one of a plurality of elements of the selected category. In some implementations, the selection region 605 also display one or more of the elements of the selected category. In some implementations, the selection region can display the category together with the element of the selection category as described before. Moreover, in some implementations, an element from the selected category may be chosen for presentation in the selection region 405 based on one or more characteristics of that element, such as a priority value that has been assigned to the element (e.g., a value indicating importance), frequency with which the element has been selected by the user (or group of users). In addition, in some implementations, the element may be chosen based on how it compares with other elements that belong to the selected category. For example, the element may be chosen based on having the highest priority value or being the most-frequently chosen element.

The arrangement of the elements (the elements of the selection category) of the second list 610 can be changed by a user gesture. For example, when the user gestures in a first direction (e.g., from the bottom left to the top right), the elements of the second list 610 can be moved in the first direction by a certain range. The positions of the elements D-5, D-6, D-7, D-1, D-2, D-3, and D-4 can be rotated and moved by one region, to result in the order of D-4, D-5, D-6, D-7, D-1, D-2, and D-3. Hence, the element D-7 can be placed in the selection region. The element movement range can be determined by the user gesture as well. While the user gesture for moving the category and the element can be made on the corresponding list, that gesture can also be made outside of the of the list (i.e., the gesture need not touch the list) Every time a new category is selected by using the first list, new elements that belong to the new category may be assigned to the regions from the second list, thereby causing the electronic device to display the elements of the newly-selected category.

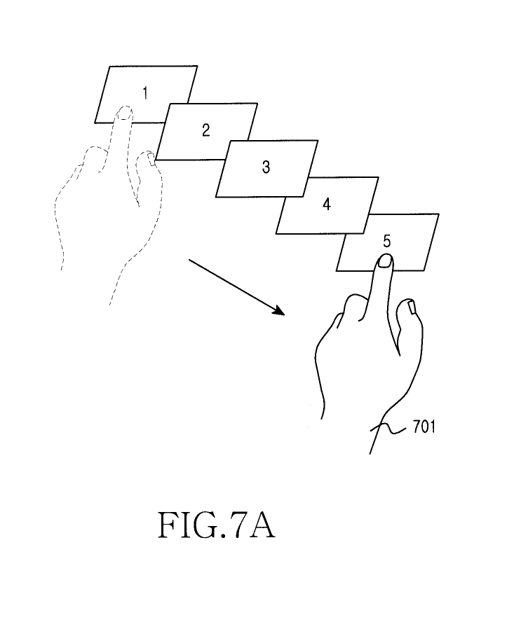

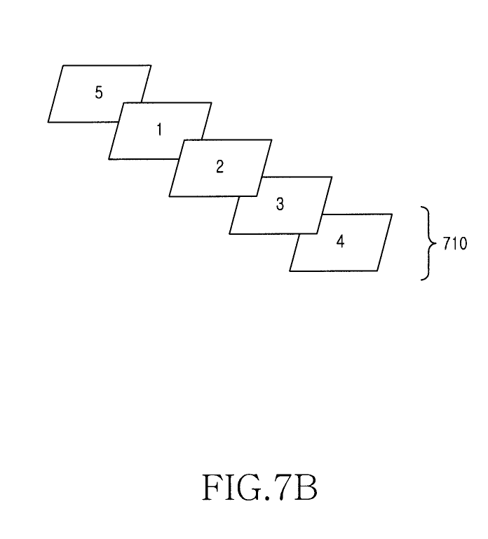

FIGS. 7A and 7B are diagrams of yet another screen for presentation of information in accordance with aspects of the disclosure. In particular, FIGS. 7A and 7B depict an example of a technique for changing the arrangement of elements (e.g., categories, sub-categories, elements of categories, media) according to aspects of the disclosure. As shown, the electronic device can display a plurality of elements by using a list that that includes multiple regions. Each of the elements may be allocated (or assigned) to a different region. In the example of FIG. 7A, element 1 is assigned to the leftmost region and element 5 is assigned to the rightmost region.

The positions of the displayed elements can be changed by a user gesture as shown in FIG. 7A. When a touch-and-drag 701 from the top left to the bottom right is detected, the arrangement 710 of the displayed elements can change as shown in FIG. 7B.

The element movement range can be determined by the length, the number of times, the speed, and the pressure of the touch-and-drag. For example, when the touch-and-drag of a preset length is detected, the elements can be scrolled by one region in the corresponding direction. By contrast, when the touch-and-drag over the preset length is detected, the elements can be scrolled by two regions in the corresponding direction. Although in this example the user gesture is a touch-and-drag, in other examples other types of gestures may be used.

As noted above, in some implements, the appearance of elements moving (e.g., categories, subcategories, category elements, content items) may be created by executing one or more of the steps of: deleting old assignments of elements to the regions in the list, assigning a new element to each region, and re-rendering that region after the new element is assigned. Additionally or alternatively, in some implementations, the appearance of elements moving may be created by executing one or more of the steps of: for each of one or more regions, changing a coordinate associated with the region from a first coordinate value to a second coordinate value, and re-rendering the region at second coordinate.

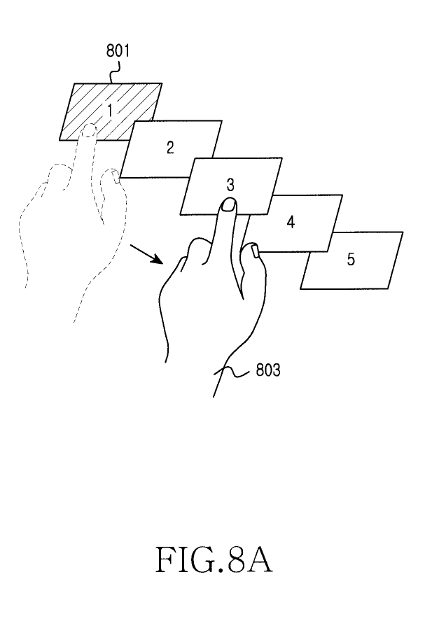

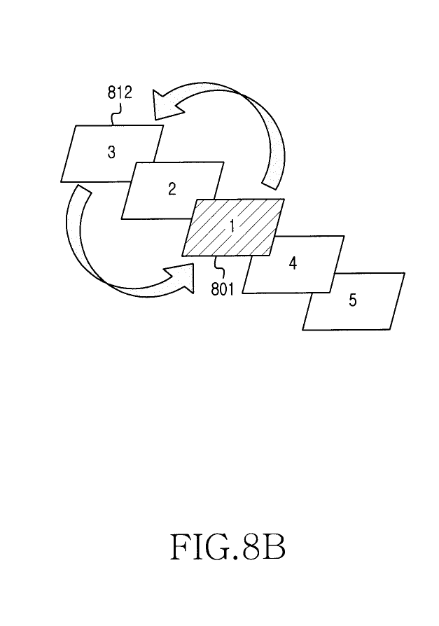

FIGS. 8A and 8B are diagrams of yet another screen for presentation of information in accordance with aspects of the disclosure. In particular, FIGS. 8A and 8B depict an example of a technique for changing the arrangement of elements (e.g., categories, subcategories, elements of categories, media) according to aspects of the disclosure. As shown, the electronic device can display a plurality of elements by using a list that that includes multiple regions. Each of the elements may be allocated (or assigned) to a different region. In the example of FIG. 8A, element 801 is assigned to the leftmost region. When an element 801 at the top left is selected and then a user gesture 803 is detected for moving the element to the center region of the list, which can be a selection region, the electronic device can move the element selected by the user to the center of the list as shown in FIG. 8B. For example, element 801 can be swapped with element 812, as shown. In some implementations, the elements may be swapped by allocating element 801 to the center region and allocating element 812 to the leftmost region. In some implementations, the center region may be a selection region and thus the gesture 803 may be used to select a category that is displayed using the list.

In some implementations, the appearance of elements being swapped may be created by assigning the element 801 to the center region and assigning the element 812 to the leftmost region. Additionally or alternatively, in some implementations, the appearance of elements being swapped may be created by associating the leftmost region with the coordinates of the central region, associating the central region with the coordinates of the leftmost region, assigning the central region as a selection region, and re-rendering the two regions.

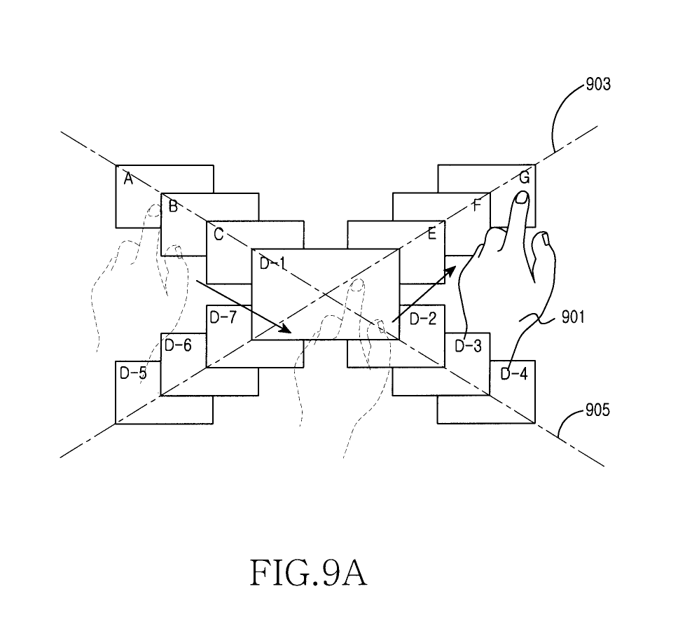

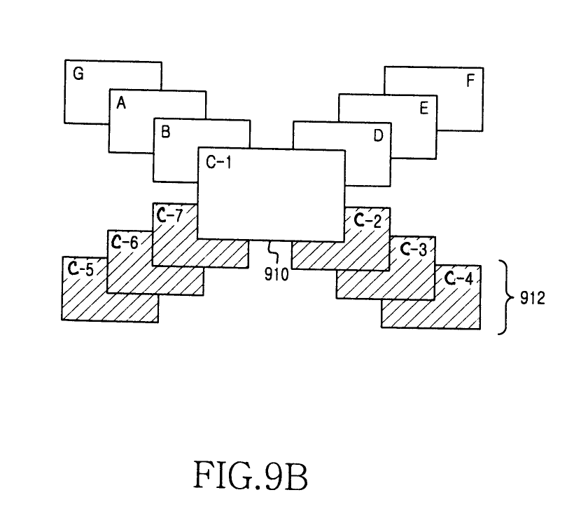

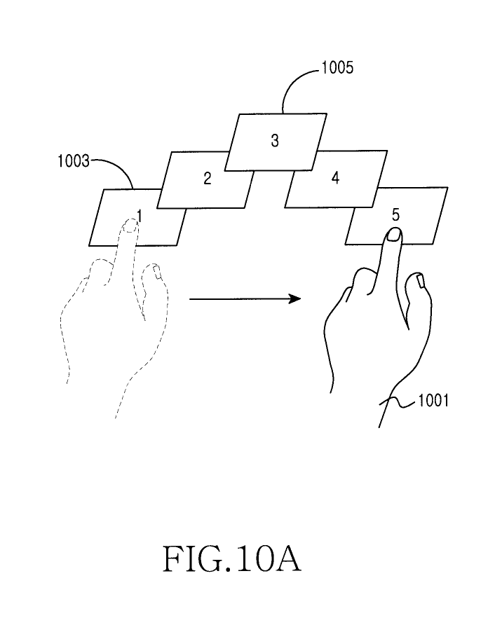

FIGS. 9A and 9B are diagrams of yet another screen for presentation of information in accordance with aspects of the disclosure. Referring to FIG. 9A, to display the elements, the electronic device can use a first list and a second list. The first list can include a plurality of regions for displaying categories of grouped elements and the second list can include a plurality of regions for displaying elements that belong to a selected category. In some implementations, the electronic device can display both of the first list and the second list. Additionally or alternatively, the electronic device can display the first list first and then output the second list one when a category displayed using the first list is selected

In the example of FIG. 9A, the regions of the first list are aligned along line 903 and the regions from the second list are aligned along line 905. The regions of the first list are displayed from the top left to the top right and the regions from the second list are displayed from the bottom left to the bottom right. The selection region is aligned with both the regions from the first list and the regions from the second list. The arrangement of elements (e.g., categories) displayed using the first list can be altered by a user gesture 901 in the manner discussed with respect to FIGS. 7A-7B and 8A-8B. For example, the gesture 901 may be used to change the ordering of the elements displayed using the second list 912 or place a particular element that is displayed using the first list into the selection region 910.

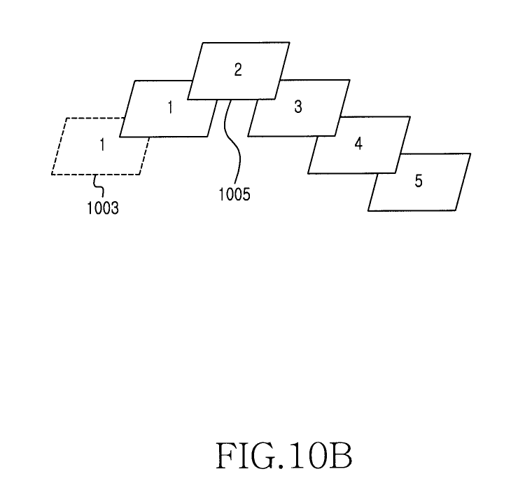

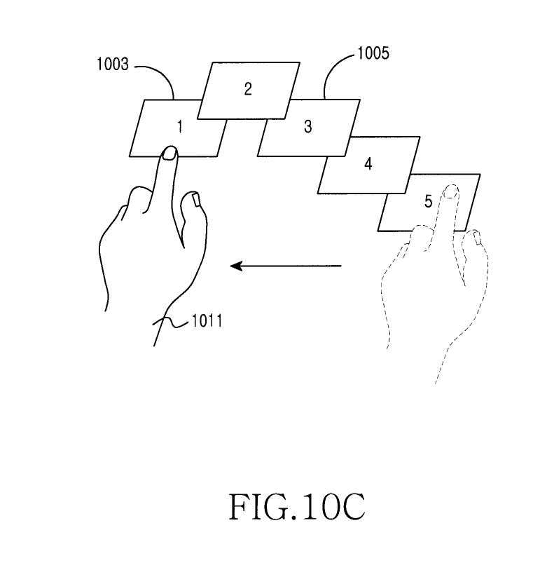

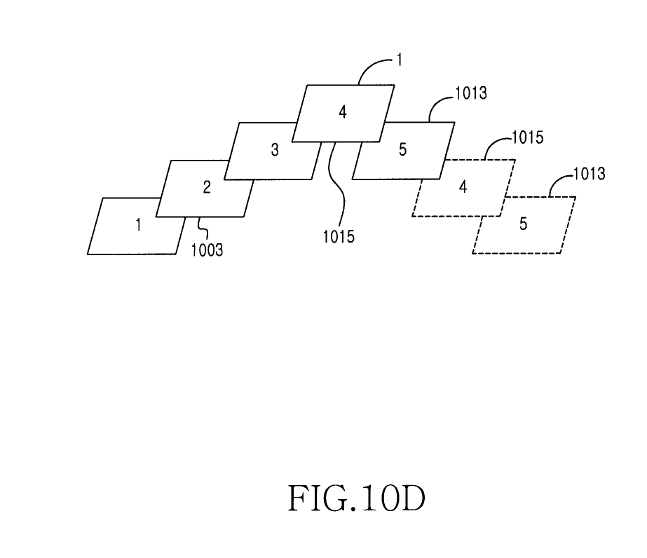

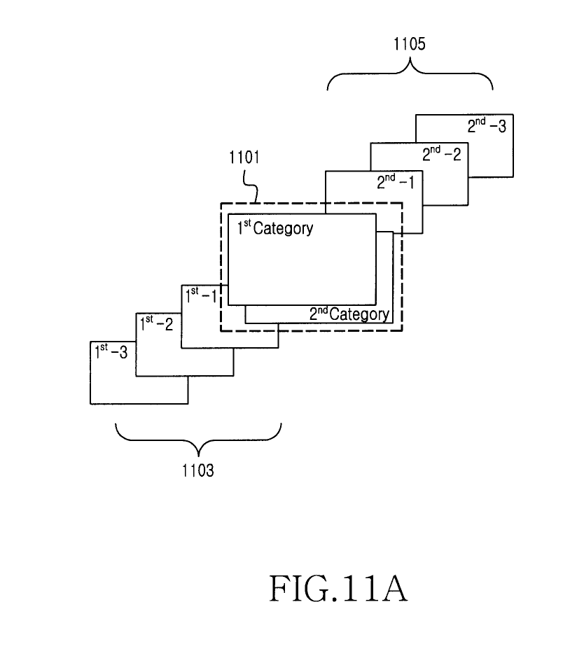

FIGS. 10A-D are diagrams of yet another screen for presentation of information in accordance with aspects of the disclosure. In this example, the electronic device can display the elements using a list that includes a plurality of regions. Each of the regions may be used to display a different one of the plurality of elements (e.g., categories, members of categories, media). The elements in the list may be arranged as shown in FIG. 10A with a topmost element being positioned higher than all other elements on the screen. In this example, the topmost element may be selected in a selection region (e.g., a selection region of a list of regions used to display the plurality of elements).

When the gesture 1001 from the left to the right is detected, the elements can shift as shown in FIG. 10B without rotating. In this example, the elements may not be rotated. That is, the element on the far right of the topmost element may not be moved to the left side of the topmost element. For example, when two elements are arranged on each side of the topmost element and the user gesture 1001 is detected, the elements 1003 and 1005 may be shifted to the right, thereby placing the element 1005 in the selection region. Thus, one element may remain on the left side and three elements may be placed on the right side of the topmost element. By contrast, if the elements were to be rotated, the rightmost element would be moved to the left side thereby causing two elements to remain on each side of the topmost element. Subsequently, when the list region arrangement is changed according to the user gesture 1001 and a second user gesture 1011 is detected as shown in FIG. 10C, the arrangement of the elements of the displayed list can change as shown in FIG. 10D. As shown, in FIG. 10D, elements 1013 and 10015 may shift to the left so that element 1015 is placed in the selection region, so that three elements are located on the left side of this element while one remains on its right side.

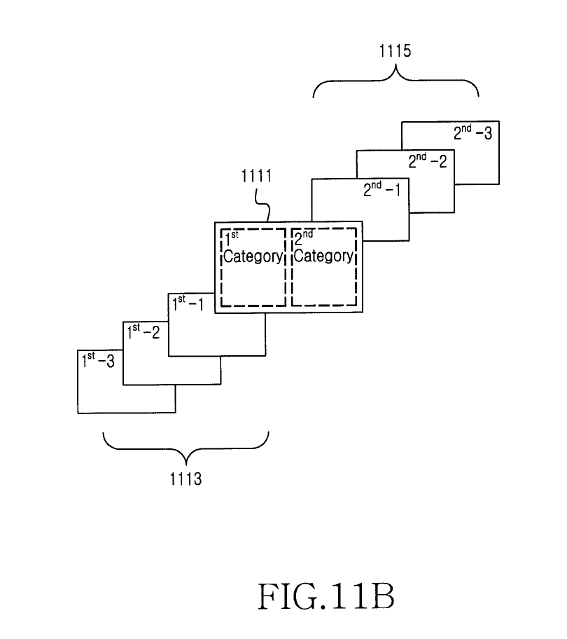

FIG. 11A is a diagram of yet another screen for presentation of information in accordance with aspects of the disclosure. In particular, FIG. 11A depicts an example of a technique for displaying of elements according to yet another aspect of the disclosure. In this example, the electronic device can display a first list 1103 and a second list 1105. The first list 1103 may include a first plurality of regions and the second list 1105 may include a second plurality of regions. Each one of the regions in the first list 1103 may be allocated one of a plurality of elements of a first category that has been selected by a user. Each one of the regions in the second list 1105 may be allocated one of a plurality of elements of a second category that has been selected by a user. The first category and the second category may be selected by using any one of techniques discussed above. The first category and the second category may be displayed inside the selection regions 1101.

In some implementations, one of the selection regions 1101 may be displayed on top of another one of the regions 1101. The user may specify which selection region is to be on top by using a switching gesture. That is, the user gesture can display the first selection region or the second selection region. Notably, the selection region can be switched by an input button (e.g., a volume control key) of the electronic device. When the electronic device is switched to displaying the second category on top, the electronic device can display the elements associated with the second list 1105. When the second list is displayed, the electronic device can change the arrangement of the elements displayed using the second list by using any of the techniques discussed with respect to FIGS. 7A-10D. In some implementations, the display device may display only elements corresponding to the category that is displayed in the selection region that is on top.

In instances where the elements of the first selection region and the elements of the second selection region are displayed at the same time, the electronic device needs to distinguish the elements to change the arrangement using the gesture. As such, the plurality of elements may be displayed, each using a different list of regions. Presenting different pluralities of elements of the same time may be used to compare data sets that belong to different categories. For example, a plurality of image data can be classified and stored as a single group. To compare the image data of a first group with the image data of a second group, the user puts his/her intended image data of the first group in the first selection region and puts the image data, to be compared, of the second group in the second selection region. FIG. 11B is a diagram of yet another screen for presentation of information in accordance with aspects of the disclosure. In particular, FIG. 11B depicts an example of a technique for displaying of elements according to yet another aspect of the disclosure. In this example, the electronic device can display a first list 1113 and a second list 1105. The first list 1113 may include a first plurality of regions and the second list 1115 may include a second plurality of regions. Each one of the regions in the first list 1113 may be allocated one of a plurality of elements of a first category that has been selected by a user. Each one of the regions in the second list 1115 may be allocated one of a plurality of elements of a second category that has been selected by a user. The first category and the second category may be selected by using any one of techniques discussed above. The first category and the second category may be displayed inside the selection region 1111.

In some aspects, the technique of FIG. 11B can be used to compare data that is part of different categories. For example, images that are part of the first category may be displayed using the first list 1113 and images that are part of the second group may be displayed using the second list 1115. Presenting the images from the two categories side by side may facilitate the comparison of images from the two categories.

In some aspects, electronic device can change the arrangement of the elements displayed using the second list by using any of the techniques discussed with respect to FIGS. 5A-10D.

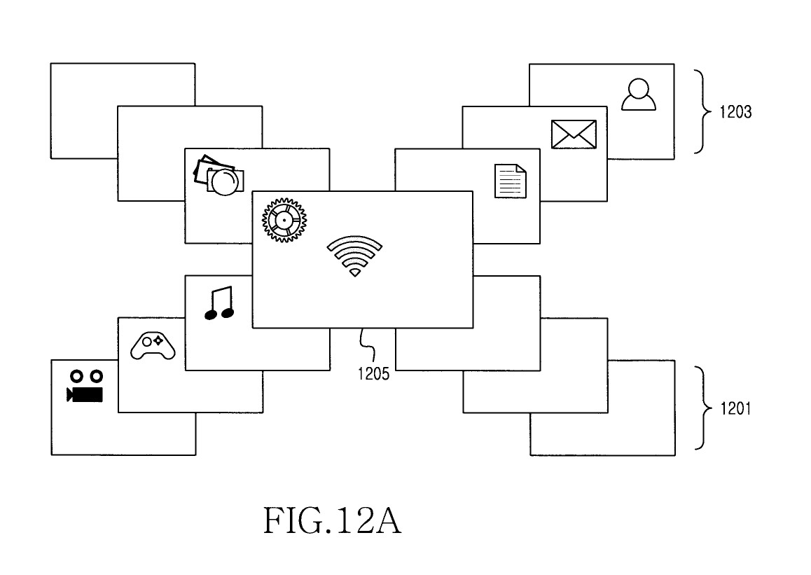

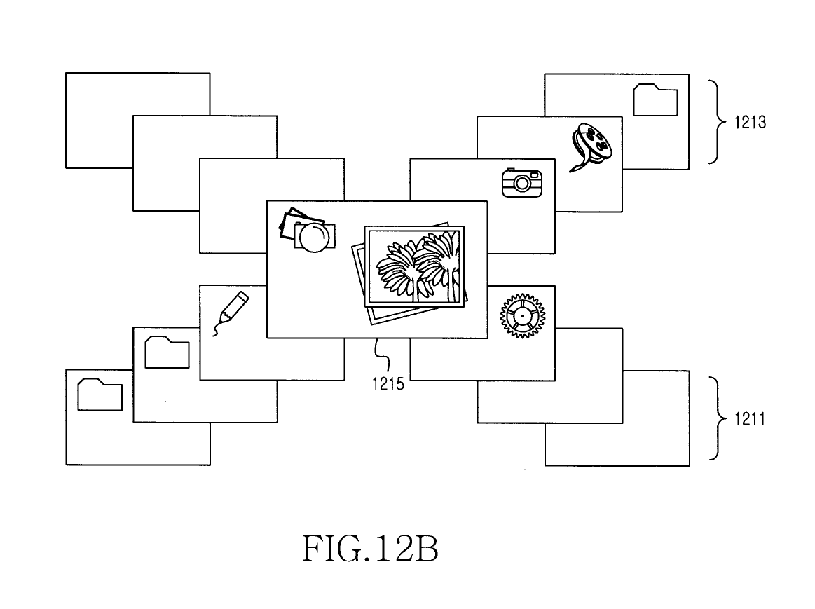

FIGS. 12A and 12B are diagrams of yet another screen for presentation of information in accordance with aspects of the disclosure. In particular, FIGS. 12A and 12B depict examples of a technique for accessing different settings the electronic device according to a yet another aspect of the disclosure. The settings of the electronic device may be organized by using a first list for displaying a plurality of categories. The categories may include a general settings menu, a camera setup menu, and/or any other suitable type of settings menu.

Referring to FIG. 12A, the electronic device displays elements of a general setup menu (category). The general setup menu can include elements such as Wi-Fi setup, audio setup, game setup, video setup, memory setup, e-mail setup, message setup, and Bluetooth setup. The setup menu may be allocated to a first region of a list of regions 1201 and a camera setup menu may be allocated to a second region of the list 1201. The different elements to the general setup menu 1201 may be allocated to regions of a second list 1203 when the general setup menu is selected by a user.

In some implementations, the user may switch between the general setup menu and the camera setup menu by dragging each of the menus into a selection region 1205. For example, when the user puts the camera setup category in the selection region, the electronic device can change the element list displaying the elements of the setup category with the elements of the camera setup as shown in FIG. 12B. Doing so may include allocating elements that belong to the camera setup menu to regions in the second list 1205 and re-rendering the list.

As noted above, in some implements, the appearance of elements moving (e.g., categories, subcategories, category elements, content items) may be created by using blank regions (i.e., regions that have not been assigned elements). Thus, when the elements are shifted to the right, a blank region on the right can be assigned a new element and re-rendered, while an assignment of the leftmost region is deleted, thereby causing the region to appear blank. Otherwise, as noted above, the appearance of elements moving may be created by executing one or more of the steps of: deleting old assignments of elements to the regions in the list, assigning a new element to each region, and re-rendering that region after the new element is assigned. Additionally or alternatively, in some implementations, the appearance of elements moving may be created by executing one or more of the steps of: for each of one or more regions, changing a coordinate associated with the region from a first coordinate value to a second coordinate value, and re-rendering the region at second coordinate.

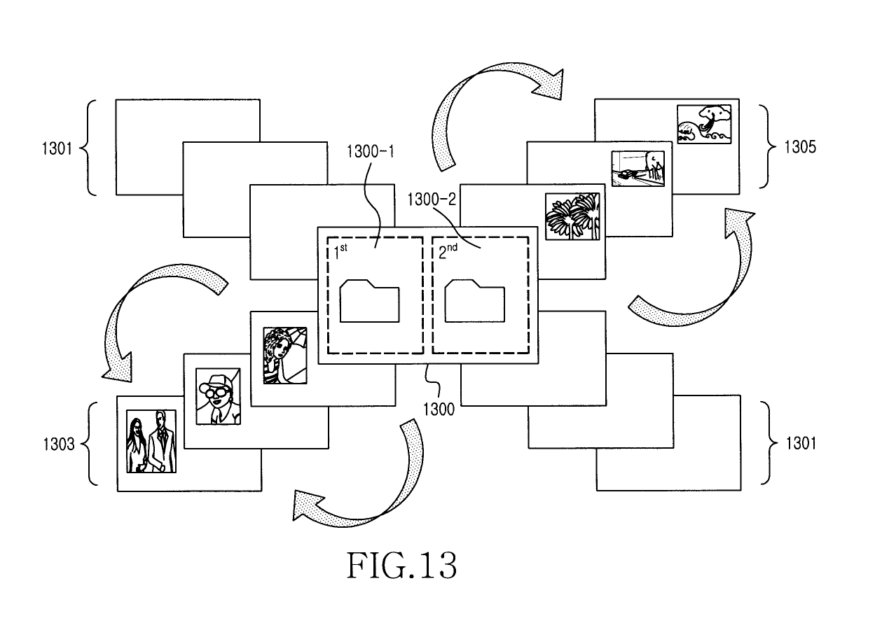

FIG. 13 is a diagram of yet another screen for presentation of information in accordance with aspects of the disclosure. In particular, FIG. 13 depicts an example of a technique for displaying elements in the electronic device according to yet another aspect of the disclosure. Referring to FIG. 13, to display the elements, the electronic device can display a plurality of categories using a first list of regions and a plurality of elements using a second list of regions and a third list of regions. In this example, the categories may represent groups of images, and the elements may represent images that belong to the different categories.

The selection region 1300 can be divided into a plurality of portions 1300-1 and 1300-2 to select multiple groups. The list connected from the top left to the bottom right corresponds to a list of regions 1301, and the selection region 1300 including the first selection region and the second selection region is placed at the center of the list of regions 1301. The list or regions 1301 may be used to display a plurality of categories (e.g., groups of images) A list of regions 1303 may be used to display elements (e.g., images) that belong to a first category that is selected using the portion 1300-1 of the selection region. A list of regions 1305 may be used to display elements (e.g., images) that belong to a second category that is selected using the portion 1300-2 of the selection region.

When a user gesture puts the first category in the portion 1300-1, the first category becomes selected and elements belonging to that category may be displayed using the list of regions 1301. After placing the first category in the portion 1300-1, the user can change the arrangement of categories displayed using the list of regions 1301 and place the second group in the second selection region 1300-2. When the second group is selected, the electronic device can display the image data list 1305 corresponding to the second group.

When the image data lists of the first group and the second group are displayed and yet another user gesture is detected, the electronic device can change the arrangement of the image data that is displayed using the lists of regions 1303 and 1305. Upon detecting a gesture on the list of regions 1303 that corresponds to the first group, the electronic device can change the arrangement of the elements displayed using group of regions 1303 and place one of those elements in the portion 1300-1. By contrast, when detecting a gesture on the list of regions 1305 is detected, the electronic device can change the arrangement of the elements displayed using the list of regions 1305 and place one of those elements in the portion 1300-2.

FIGS. 14A-C are diagrams of yet another screen for presentation of information in accordance with aspects of the disclosure. In particular, FIGS. 14A-C depict an example of yet another technique for changing the arrangement of a list of regions. Referring to FIG. 14A, the electronic device can display a plurality of categories using a first list of regions. The first list can include a plurality of circular regions, and the regions can contain the respective categories. The category arrangement can be changed by the user gesture. That is, the user gesture in a first direction can scroll the categories of the first list in the first direction. The first list can include a selection region for selecting at least one of the categories of the first list. The shaded region 1401 is the selection region, and the category placed in the selection region can be changed by the user gesture. A setup category 1403 and a camera setup category 1405 are displayed around the selection region 1401.

Referring to FIG. 14B, when a user gesture puts a category in the selection region, the electronic device uses the list of regions to display elements of the category. In some implementations, the device may remove any assignments of categories to the regions in the list and assign to the regions elements of the selected category instead. Afterwards, the electronic device may re-render the list of regions. In this example, as the setup category is put in the selection region 1411, the displayed first list displays elements 1411-1 such as Wi-Fi setup, audio setup, game setup, video setup, memory setup, e-mail setup, message setup, and Bluetooth setup of the setup category. In so doing, the electronic device can display the category together with the elements in the selection region 1411.

Next, the electronic device can change the arrangement of the displayed elements according to a user gesture 1410. For example, when detecting the gesture in a preset direction, the electronic device can move the elements and change the element in the selection region.

In some implementations, the electronic device may use a predetermined gesture to change the category that is displayed using the list of regions. For instance, when detecting a user gesture 1420 as shown in FIG. 14C, the electronic device can change the category of the selection region and then display the elements of the newly-selected category by using the first list of regions. In the example of FIG. 14C, according to the user gesture, the camera setup category is placed in the selection region 1421 and the elements 1421-1 corresponding to the camera setup category are displayed in the other regions. In the example of FIG. 14C, the gesture of the first direction changes the element arrangement, and the gesture of the second direction changes the category arrangement.

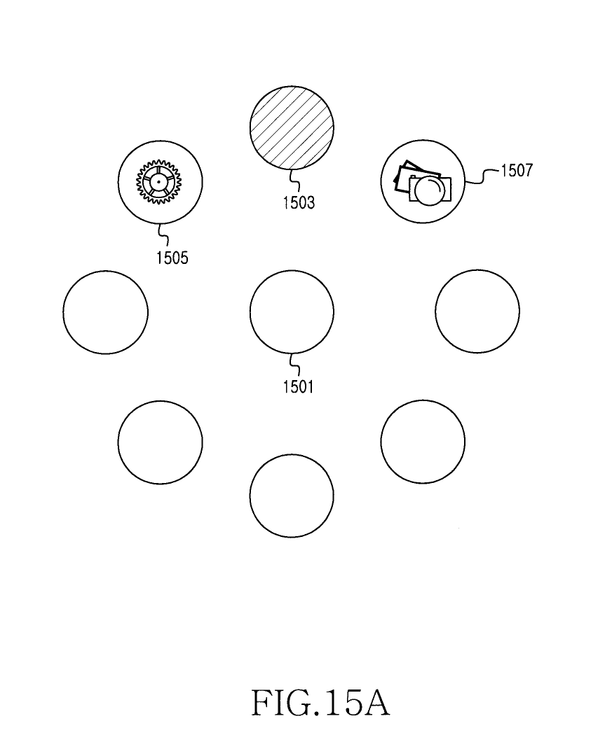

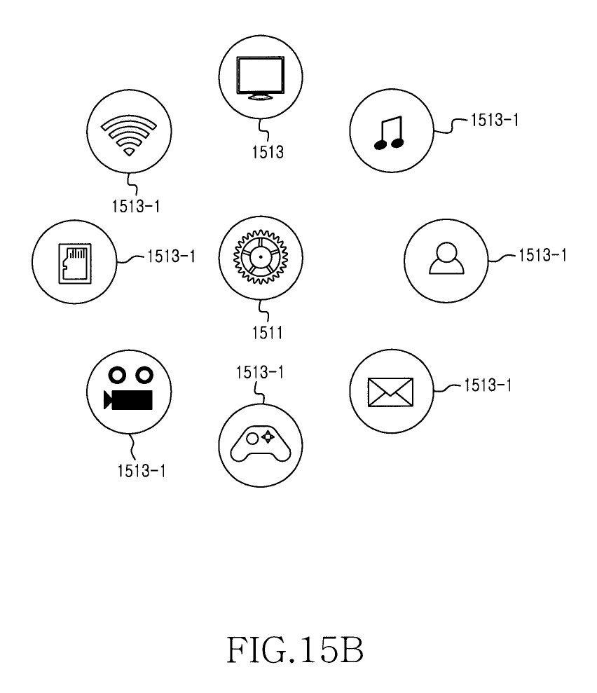

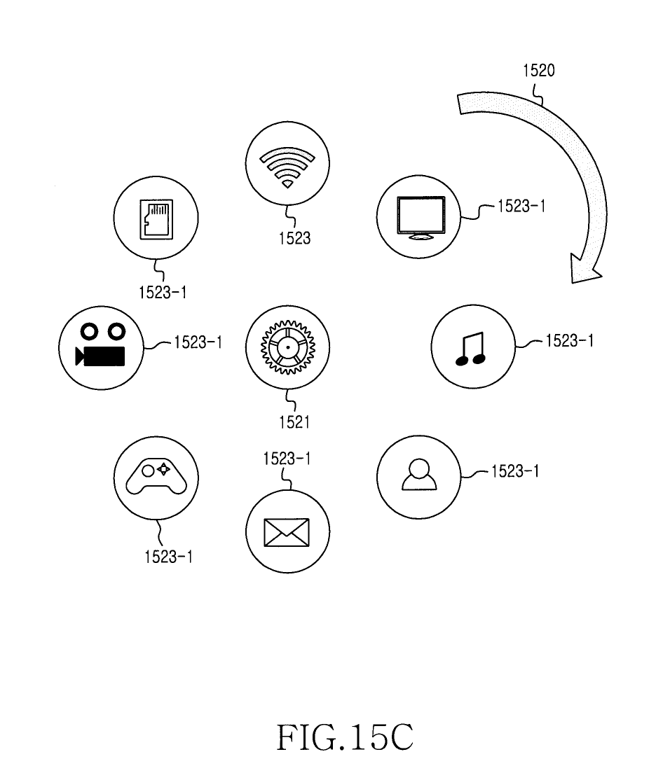

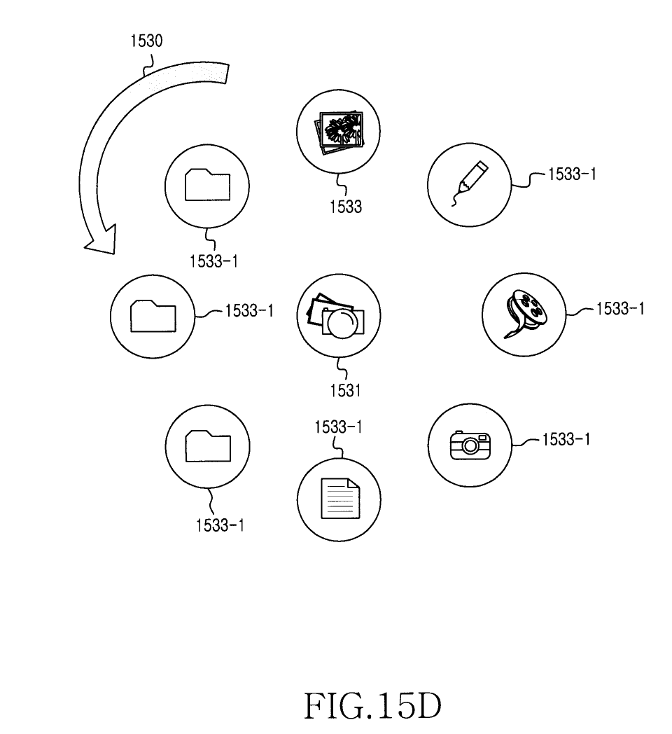

FIGS. 15A-D are diagrams of yet another screen for presentation of information in accordance with aspects of the disclosure. In particular, FIGS. 15A-D depict an example of yet another technique for changing the arrangement of a list of regions in accordance with aspects of the disclosure. Referring to FIG. 15A, the electronic device can display a plurality of categories using a first list of regions. The first list can include a plurality of circular regions, the regions can contain the respective categories, and the category arrangement can be changed by the user gesture. That is, the user gesture in a first direction can scroll the categories of the first list in the first direction. The first list can include a selection region for selecting at least one of the categories of the first list, and a selection information region for providing information about the selected category.

In the example of FIGS. 15A-D the shaded region is the selection region 1503, and the region at the center of the first list can be the selection information region 1501. When a category is put in the selection region 1503, that category can be shifted to the selection information region 1501 and elements of the category can be displayed by using the first list. As shown, a setup category 1505 and a camera setup category 1507 are displayed around the selection region 1503.

Referring to FIG. 15B, when the user gesture puts the setup category in the selection region, the electronic device moves the setup category from the selection to the selection information region 1511 and displays elements 1513-1 such as Wi-Fi setup, audio setup, game setup, video setup, memory setup, e-mail setup, message setup, and Bluetooth setup of the setup category in the displayed first list. Next, the electronic device can change the arrangement of the displayed elements according to a user gesture. For example, when detecting a gesture in a preset direction, the electronic device can move the elements and change the element in the selection region. For instance, when detecting a user gesture 1520, as shown in FIG. 15C, the electronic device can change the displayed element arrangement in a preset direction. The elements can be moved clockwise by one element in FIG. 15C.

After the category of the selection region is changed according to the user gesture, the first list can display the elements of the changed category as shown in FIG. 15D. In so doing, the electronic device can display the changed category in the selection information region.

When a user gesture 1530 is detected, the camera setup category can be selected. The camera setup category can be moved to the selection information region 1531, and the elements 1533 corresponding to the camera setup category can be displayed using the first list.

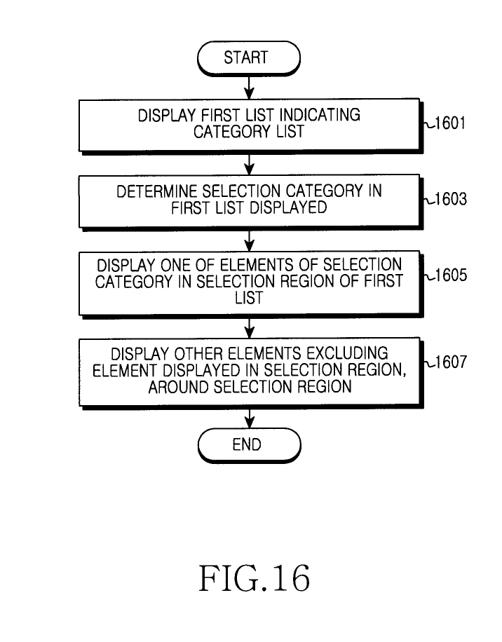

FIG. 16 is a flowchart of a still another process for displaying elements according to aspects of the present disclosure.

Referring to FIG. 16, the electronic device can display a first list indicating the list of the categories in step 1601. Herein, the category can be a single category of the grouped elements, and the first list can be the group of the categories.

The first list can include a plurality of regions, and the categories can be disposed in the respective regions. The category arrangement can be changed by the user's gesture. For example, according to the user's gesture in a first direction, the categories in the first list can be scrolled in the first direction. In so doing, the electronic device can change the arrangement in a fashion that only the category display is altered with the region arrangement fixed. For example, the electronic device can change the arrangement by applying an effect which moves the region of the arranged categories according to the user's gesture.

By contrast, the categories in the first list can be scrolled in a second direction according to the user's gesture of the second direction.

Herein, the scroll of the categories can move the categories of the first list displayed on the screen, in a preset direction.

Typically, the number of categories displayed on the screen of the electronic device can be preset. When all of the categories of the first list are not displayed on the screen, the category displayed by the user's gesture can be scrolled and the unseen categories can be displayed.

That is, as the categories displayed on the screen are moved to sequentially conceal the displayed categories, the unseen categories are displayed on the screen.

The user's gesture is a touch input on the screen (the touch screen), and the category scroll range (spacing) can be determined by gesture length, the number of times, speed, and pressure. For example, the user gesture can be a touch-and-drag. When the touch-and-drag of a preset length is detected, the displayed categories can be scrolled by one region in a direction corresponding to the touch-and-drag. By contrast, when the touch-and-drag over the preset length is detected, the displayed categories can be scrolled by two regions in the direction corresponding to the touch-and-drag.

The first list allocates the selection region for selecting at least one of the categories of the first list. When the category is placed in the selection region, the category becomes the selection category and the list of the elements of the selection category can be displayed. That is, the selection region may not display the selection category but may display at least one of the elements of the selection category. For example, the selection region can concurrently display the selection category and at least one of the elements of the selection category.

The element can be the lower menu of the higher menu. For example, the higher menu (the category menu) of the setup can include the lower menus such as video setup and audio setup. Accordingly, the setup menu becomes the category and its lower menus can be the elements.

The element can include the contents stored in the electronic device.

For example, a gallery folder can store image data. Hence, the gallery folder becomes the category, and the image data in the folder become the elements.

In step 1603, the electronic device can confirm the category selected by the user in the first list displayed. The selection category is determined by the user's gesture, and the user can put the category including the element to check in the selection region using the gesture in order to determine the selection category.

In step 1605, the electronic device confirms the elements of the selection category and displays at least one of the confirmed elements in the selection region of the first list.

In step 1607, the electronic device can display the other elements excluding the element displayed in the selection region, around the selection region. Herein, the elements displayed around the selection region can be defined as a second list. The second list groups the elements corresponding to the selection category. The electronic device displays both of the first list and the second list, to efficiently display the elements and the categories on the screen of the limited size.

Like the first list, the second list can include a plurality of regions and the regions can contain the elements. Such an element arrangement can be changed by the user gesture. That is, as the elements are scrolled according to the user gesture, the element in the selection region can be changed. The element in the selection region can be executed by the electronic device. For example, when the user touches and drags the element “video setup” into the selection region and releases the touch-and-drag, the electronic device can display a video setup screen.

While the region of the categories in the first list can be same as the selection region in size, the selection region can be larger than the category region so that the user can easily identify the element to select.

While the region of the elements in the second list can be same as the selection region in size, the selection region can be larger than the element region.

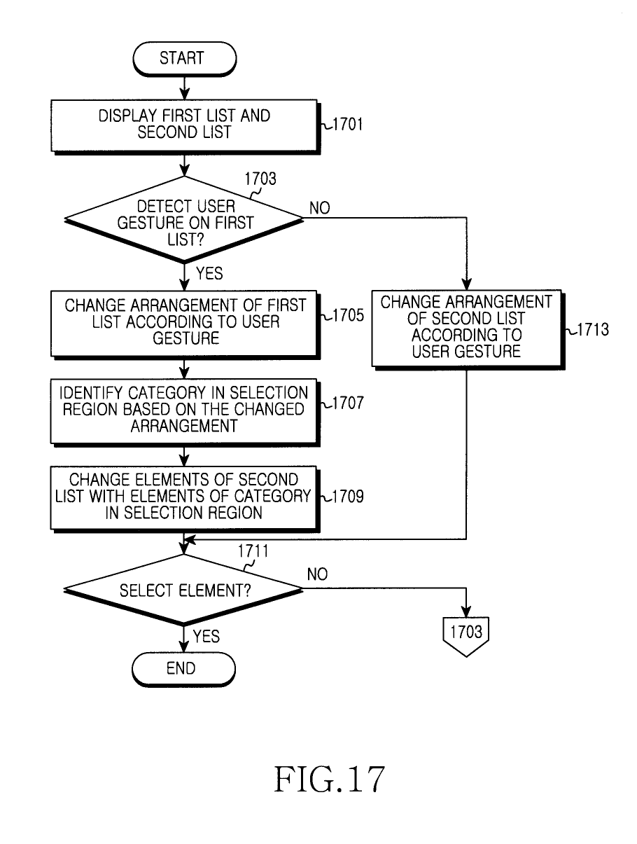

FIG. 17 is a flowchart of a further still another process for displaying elements according to aspects of the present disclosure

Referring to FIG. 17, the electronic device can display the first list corresponding to the category list and the second list corresponding to the element list, and execute the element while changing the arrangement of the displayed first and second lists according to the user gesture.

The elements in the second list can be the lower menus (the video setup and the audio setup) of the higher menu (the menu category such as setup menu) of the electronic device. In this case, the element category becomes the higher menu. The elements in the second list can be the contents (image data, audio data, and video data) stored in the folder which groups the contents stored in the electronic device. In this case, the element category becomes the folder of the grouped contents.

To execute the element, the electronic device can display the first list and the second list in step 1701.

In step 1703, the electronic device can determine whether the user gesture for the first list displayed is detected.

Herein, as mentioned in FIG. 16, the first list can include the plurality of the regions and the regions can include the respective categories. The second list can also include the plurality of the regions and the regions can include the respective elements. The first list allocates the selection region for selecting at least one of the categories of the first list, the selection region becomes the region of the second list, and the second list can be formed around the selection region.

When detecting the user gesture for the first list, the electronic device can change the arrangement of the first list according to the user gesture in step 1705.

That is, the electronic device can sequentially move the displayed categories in the direction corresponding to the gesture, according to the user gesture. The electronic device can detect the user gesture for the second list and change the arrangement of the second list.

In some cases, all of the categories are not displayed in the first list. In this case, the electronic device can move the displayed categories to sequentially hide the displayed categories, and concurrently display the unseen categories on the screen.

In step 1707, the electronic device can identify the category placed in the selection region according to the changed arrangement.

In step 1709, the electronic device can display the elements corresponding to the category placed in the selection region, in the second list.

In so doing, the electronic device can replace the category displayed in the selection region with the elements.

For example, the electronic device can display the category in some of the selection region and the elements in other region so that the user can recognize both of the element in the selection region and the category of the element.

When the category arrangement is changed, the electronic device can preferentially place the element of high priority (importance or name) and the element of high user selection frequency, among the elements corresponding to the category, in the selection region.

In step 1711, the electronic device can determine whether the user gesture selects the element.

Herein, the element selection can change the element arrangement of the second list according to the user gesture and arrange the element in the selection region.

For example, when the user touches and drags the element “video setup” into the selection region and releases the touch-and-drag, the electronic device can determine that the element “video setup” is selected.

When the element is not selected, the electronic device can detect the user gesture for changing the arrangement of the first list or the second list.

Upon detecting the user gesture for the second list in step 1703, the electronic device can change the arrangement of the second list according to the user gesture in step 1705.

In step 1711, the electronic device can determine whether the element is selected according to the changed arrangement of the second list.

When the element is selected, the electronic device can execute the selected element.

As set forth above, the electronic device and the method for displaying the category display the category list and the element list and change the category or element arrangement according to the user gesture. Therefore, screen of limited size can display multiple categories and multiple elements, thus causing element selection to be simplified.

While the disclosure has been shown and described with reference to certain exemplary embodiments thereof, it will be understood by those skilled in the art that various changes in form and details may be made therein without departing from the spirit and scope of the disclosure as defined by the appended claims and their equivalents.

The above described methods are provided as an example only. Steps of those processes may be executed in any order, executed concurrently, or altogether omitted. By way of example, step 205 may be omitted in some implementations. It should that the term “list of regions” is defined as “a set of one or more regions” or “a group of one or more regions.” As such, the word “list” does not imply anything about the representations at the program level. The lists of regions and regions thereof may be represented using any suitable type and/or number of data structure, variable, and/or another type of representations. Furthermore, it should be noted that any suitable type of gesture can be used to trigger the functions discussed herein, such as a gesture that includes a tap, a gesture that includes a plurality of taps, a gesture that includes a sliding motion, and or any other type of motion or interaction with an input device (e.g., a touch screen).

The above-described embodiments of the present invention can be implemented in hardware, firmware or via the execution of software or computer code that can be stored in a recording medium such as a CD ROM, a Digital Versatile Disc (DVD), a magnetic tape, a RAM, a floppy disk, a hard disk, or a magneto-optical disk or computer code downloaded over a network originally stored on a remote recording medium or a non-transitory machine readable medium and to be stored on a local recording medium, so that the methods described herein can be rendered via such software that is stored on the recording medium using a general purpose computer, or a special processor or in programmable or dedicated hardware, such as an ASIC or FPGA. As would be understood in the art, the computer, the processor, microprocessor controller or the programmable hardware include memory components, e.g., RAM, ROM, Flash, etc. that may store or receive software or computer code that when accessed and executed by the computer, processor or hardware implement the processing methods described herein. In addition, it would be recognized that when a general purpose computer accesses code for implementing the processing shown herein, the execution of the code transforms the general purpose computer into a special purpose computer for executing the processing shown herein.

What is claimed is:

1. A method in an electronic device, comprising:
displaying, on a display screen, a plurality of categories, the plurality of categories being displayed in a first direction;
detecting, by a processor, a selection of a category from the plurality of categories;
modifying an arrangement in which the plurality of categories are displayed, the modifying including displaying the category in a selection region, such that the category is at least partially superimposed over other ones of the plurality of categories, and
displaying, on the display screen, a plurality of elements of the category, the plurality of elements being displayed in a second direction that is different from the first direction.

2. The method of claim 1, wherein the arrangement in which the plurality of categories is displayed is modified responsive to a user gesture that is designated for selection of categories.

3. The method of claim 1, further comprising modifying an arrangement in which elements from the second list are displayed responsive to a user gesture that is designated for selection of category elements.

4. The method of claim 1, further comprising associating elements belonging to the category with a list of regions, the associating being responsive to the selection of the category.

5. The method of claim 1, wherein:
displaying the plurality of categories in a first direction includes displaying at least some of the plurality of categories along a first line; and
displaying the plurality of elements in a second direction includes displaying at least some of the plurality of elements along a second line that crosses the first line at least once.

6. The method of claim 1, wherein the selection region is configured to display one or more elements of the category.

7. The method of claim 1, wherein the selection region is configured to display multiple categories that have been selected.

8. An electronic device comprising:
a display screen; and
a processor configured to:
display, on the display screen, a plurality of categories, the plurality of categories being displayed in a first direction;
detect a selection of a category from the plurality of categories;
modify an arrangement in which the plurality of categories are displayed, the modifying including displaying the category in a selection region, such that the category is at least partially superimposed over other ones of the plurality of categories, and
display, on the display screen, a plurality of elements of the category, the plurality of elements being displayed in a second direction that is different from the first direction.

9. The electronic device of claim 8, wherein the arrangement in which the plurality of categories is displayed is modified responsive to a user gesture that is designated for selection of categories.

10. The electronic device of claim 8, wherein the processor is further configured to modify an arrangement in which elements from the second list are displayed responsive to a user gesture that is designated for selection of category elements.

11. The electronic device of claim 8, wherein the processor is further configured to associate elements belonging to the category with a list of regions, the associating being responsive to the selection of the category.

12. The electronic device of claim 8, wherein:
displaying the plurality of categories in a first direction includes displaying at least some of the plurality of categories along a first line; and
displaying the plurality of elements in a second direction includes displaying at least some of the plurality of elements along a second line that crosses the first line at least once.

13. The electronic device of claim 8, wherein the selection region is configured to display one or more elements of the category.

14. The electronic device of claim 8, wherein the selection region is configured to display multiple categories that have been selected.

15. A non-transitory computer-readable storage medium storing one or more programs comprising instructions which, when executed by an electronic device, cause the device to execute the method according to claim 1.

16. A method in an electronic device, comprising:
determining a selection category among a plurality of categories; and
displaying the selection category in a selection region of a first list, displaying other categories to overlap the selection category with the other categories, and arranging and displaying a second list in a different direction from an arrangement direction of the first list,
wherein the first list is a category list and the second list is a list of elements of the selection category, and
the selection region arranges at least one of the elements.

17. The method of claim 16, wherein a category arrangement of the first list is changed by a user gesture.

18. The method of claim 16, wherein an element arrangement of the second list is changed by a user gesture.

19. The method of claim 16, wherein, when the selection category of the first list is changed, elements corresponding to the changed category are included and displayed in the second list.

20. The method of claim 16, wherein the different direction crosses the arrangement direction of the first list.

21. The method of claim 16, wherein the selection region displays elements of the category selected by the user gesture, or displays the selected category and elements together.

22. The method of claim 16, wherein the selection region comprises a first selection region and a second selection region, and displays a second list corresponding to each selection region.
